(19) United States
(12) Patent Application Publication
(10) Pub. No.: US 2006/0226671 A1
(43) Pub. Date: Oct. 12, 2006

(54) Truck topper

(75) Inventors: Randy C. Thole, Osceola, IA (US); Robert J. Wolf, Chariton, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Astoria Industries of Iowa, Inc., Chariton, IA (US)

(21) Appl. No.: 11/101,809

(22) Filed: Apr. 8, 2005

(51) Int. Cl. B62D 33/04

(52) U.S. Cl. 296/24.45

(57) ABSTRACT

A truck topper having a front end, a rear end, a top, and sides for placement on the bed of a pickup truck, the topper having an opening in at least one of the sides of the topper and a shelving assembly disposed within the topper adjacent the opening, the shelving assembly secured to the top and side of the topper.

### BACKGROUND OF THE INVENTION

The present invention relates to pickup trucks and, more specifically, an improved topper for providing cargo storage on a pickup truck.

Truck toppers are well known in the art. While most toppers only provide a protective covering for the bed of a truck, such as that shown in U.S. Design Pat. No. D326,441 to Rogers, some toppers provide users with multiple compartments for storing tools and the like. One disadvantage of known truck toppers is that items stored inside the topper often are not accessible from the exterior of the truck. Rather, users often must enter the topper from the rear end to gain access to equipment or tools stored within.

U.S. Pat. No. 5,593,201 to Bateman discloses a topper having multiple bins for holding tools arranged around the inside perimeter of the truck bed. With the Bateman device, some of the storage bins are accessible from within the topper while several are only accessible from the exterior. Because many of the storage bins are positioned around the perimeter of the truck bed, space between the topper and the truck bed is limited. As such, users are unable to place large items, such as sheets of drywall or large pieces of machinery, on the bed of the truck.

U.S. Pat. No. 5,829,813 to LaValle discloses a topper with multiple drawers for holding tools that are accessible from the rear end of the truck. With the LaValle device, the storage drawers are disposed inside the topper above the truck bed, thereby overcoming the disadvantage of the Bateman device. Because the storage drawers of the LaValle device are positioned at the rear of the topper, access into the topper from the rear is limited. As such, users must duck underneath the storage drawers to enter the topper through the rear door. Accordingly, there is a need in the art for a truck topper that provides ample storage for tools and equipment that are accessible from the exterior of the topper without limiting the storage space on the bed of the truck or impeding access into the topper through the rear door.

It is therefore a principal object of this invention to provide a truck topper that allows quick access to equipment stored therein.

Another object of this invention is to provide a truck topper with storage for tools and the like that does not limit the storage space on the bed of the truck.

A further object of this invention is to provide a truck topper with storage for tools and the like that does not impede access into the topper through the rear door.

Still a further object of this invention is to provide a truck topper with shelving assemblies mounted on interior side surfaces of the topper with side openings allowing access to items stored on the shelving assemblies.

These and other objects will be apparent to those skilled in the art.

### BRIEF SUMMARY OF THE INVENTION

The present invention is directed toward a truck topper having a front end, a rear end, a top, and sides for placement on the bed of a pickup truck. An opening is provided in at least one of the sides of the topper. Additionally, a shelving assembly is disposed within the topper adjacent the opening in the side, the shelving assembly secured to the top and side of the topper. The shelving assembly is accessible from the exterior of the truck topper via the opening in the side.

### BRIEF DESCRIPTION OF THE DRAWINGS

FIG. 1 is a perspective view of the present invention as adapted for use with a pickup truck;

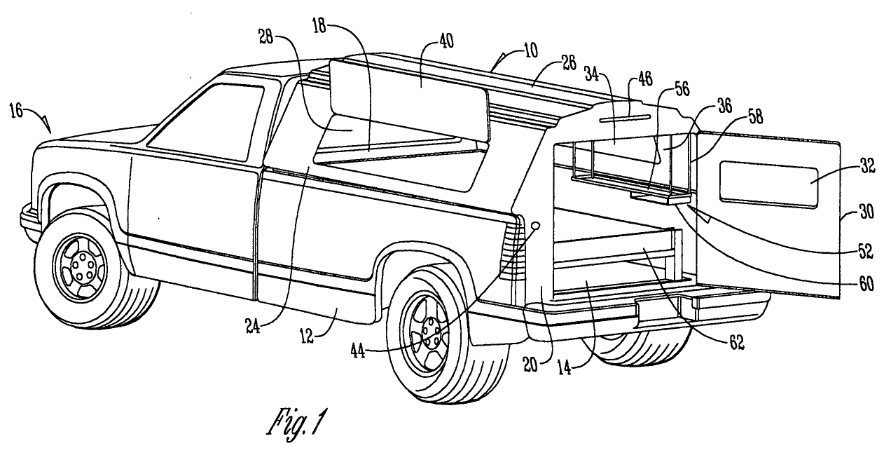

FIG. 2 is a rear view of an embodiment of the present invention;

FIG. 3 is a rear view of an embodiment of the present invention;

FIG. 4 is a side view of the present invention;

FIG. 5 is a top view of an embodiment of the present invention;

FIG. 6 is a top view of an embodiment of the present invention; and

FIG. 7 is a perspective view of a pull-out tray of the present invention.

### DESCRIPTION OF THE PREFERRED EMBODIMENTS OF THE INVENTION

With reference to the figures, a truck topper 10 is shown for placement on the side walls 12 of the bed 14 of a pickup truck 16.

The topper has a front end 18, rear end 20, sides 22 and 24, and a top 26. The front end 18 has a front window 28 that aligns with the rear window (not shown) on the cab of the truck 16. The rear end 20 has a rear door 30 pivotally connected to the rear end 20, and a rear window 32 is disposed within the rear door 30.

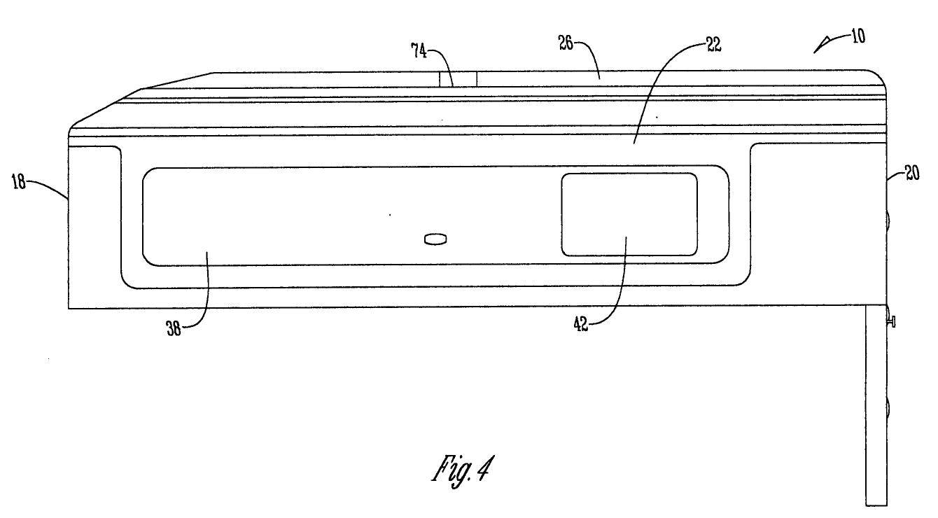

Sides 22 and 24 have openings 34 and 36, which are covered by side doors 38 and 40 pivotally connected to the sides 22 and 24. Side doors 38 and 40 may have side windows 42, as shown in FIG. 4.

Vents 44 are positioned on opposite sides of the rear door 30 on the rear end 20. Vents (not shown) may also be placed in a similar manner on the front end 18 of the topper 10 to permit adequate ventilation.

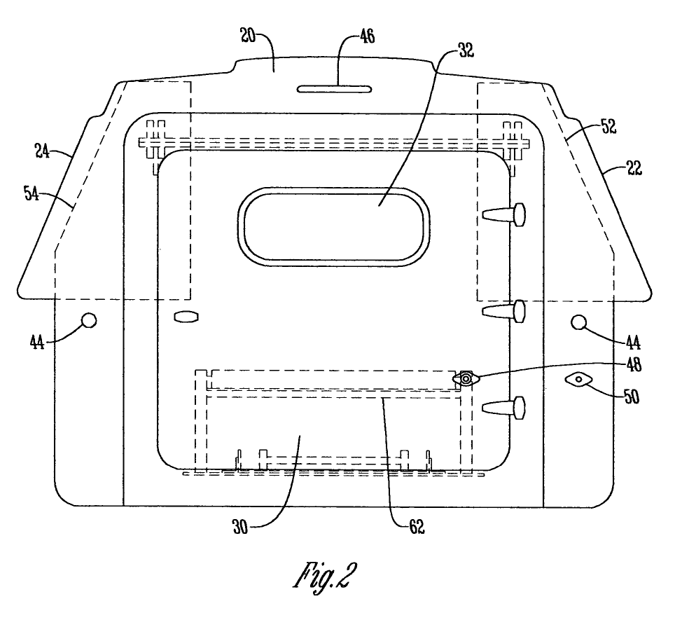

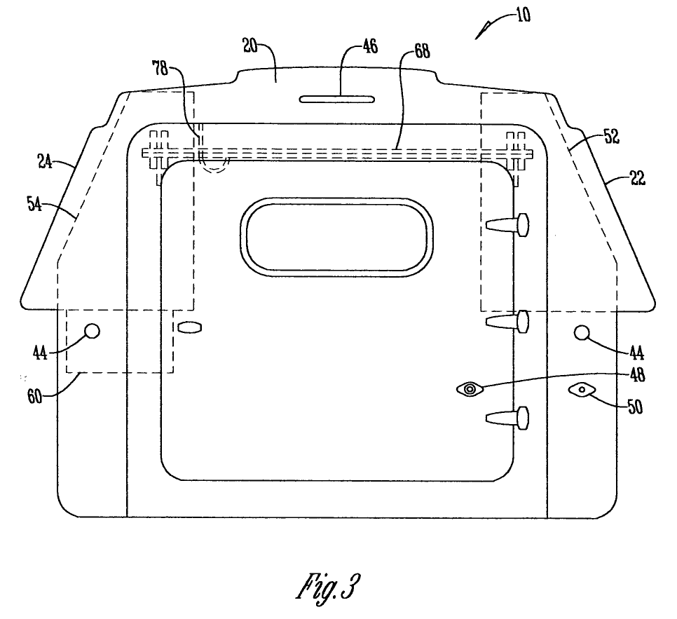

A brake light 46 is positioned above the rear door 30 on the rear end 20. Rear end 20 also has a door stop assembly comprising a male door stop member 48 that is received by a female door stop member 50 as shown in FIGS. 2 and 3 to limit the range of motion of rear door 30.

Shelving assemblies 52 and 54 are disposed within the topper 10 adjacent the openings 34 and 36 of sides 22 and 24. Shelving assemblies 52 and 54 include a horizontal shelf portion 56 that is secured to the sides 22 and 24 adjacent the openings 34 and 36 at approximately the same height as the side walls 12 of the truck 16. Shelving assemblies 52 and 54 also include vertical members 58 that secure the shelf portion 56 to the top 26 of the topper 10. Shelving assemblies 52 and 54 also may include lower compartments 60, which are attached to the underside of shelf portion 56. In this arrangement, items placed on the shelving assemblies 52 and 54 can be easily and quickly accessed from outside the topper 10 via openings 34 and 36 in sides 22 and 24.

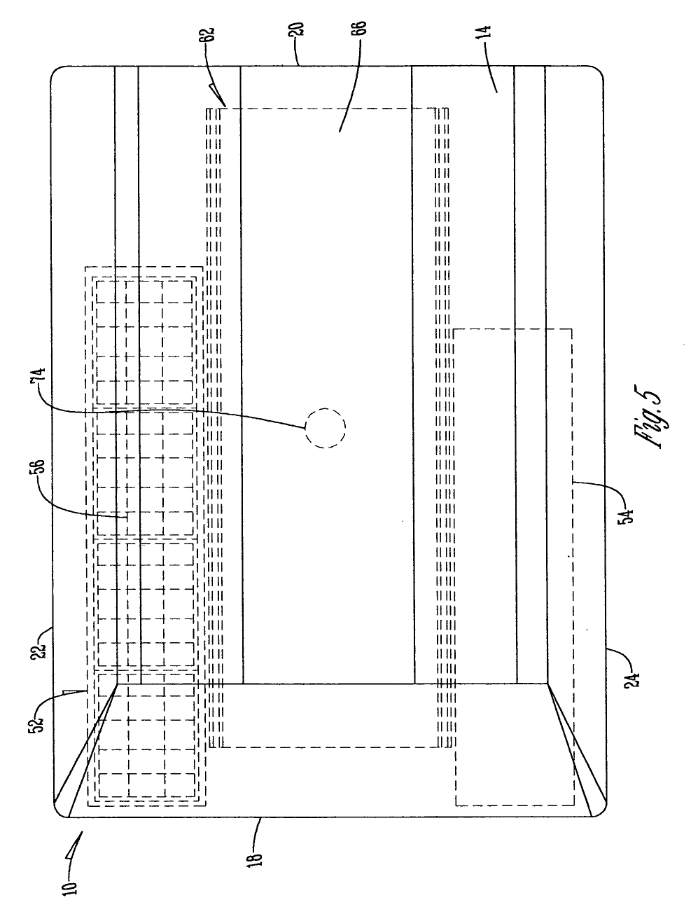

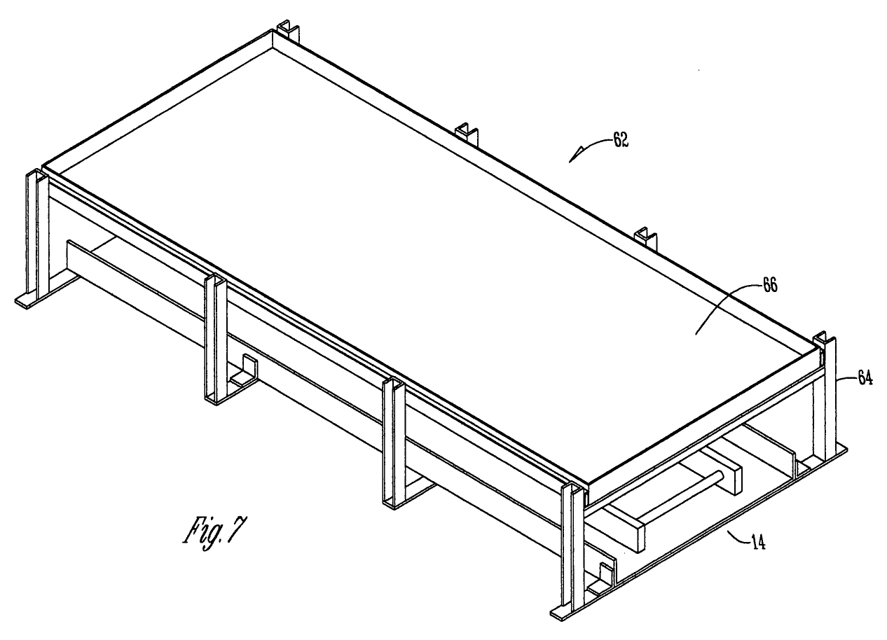

In one embodiment of the topper 10, a pull-out tray assembly 62 is secured to the bed 14 of the truck 16 and covered by topper 10, as shown in FIGS. 2 and 5. Pull-out tray assembly 62 includes a frame 64 that is secured to the bed 14, as shown in FIG. 7. Frame 64 supports a tray 66, which slides laterally with respect to the frame 64. As such, tools and the like may be placed on the tray 66, which can be pulled outwardly from the topper 10 via rear door 30 for easy access of the items placed thereon. Additionally, items such as a six-foot step ladder may be stored underneath the tray 66 on the bed 14 of the truck 16 as shown in FIG. 7.

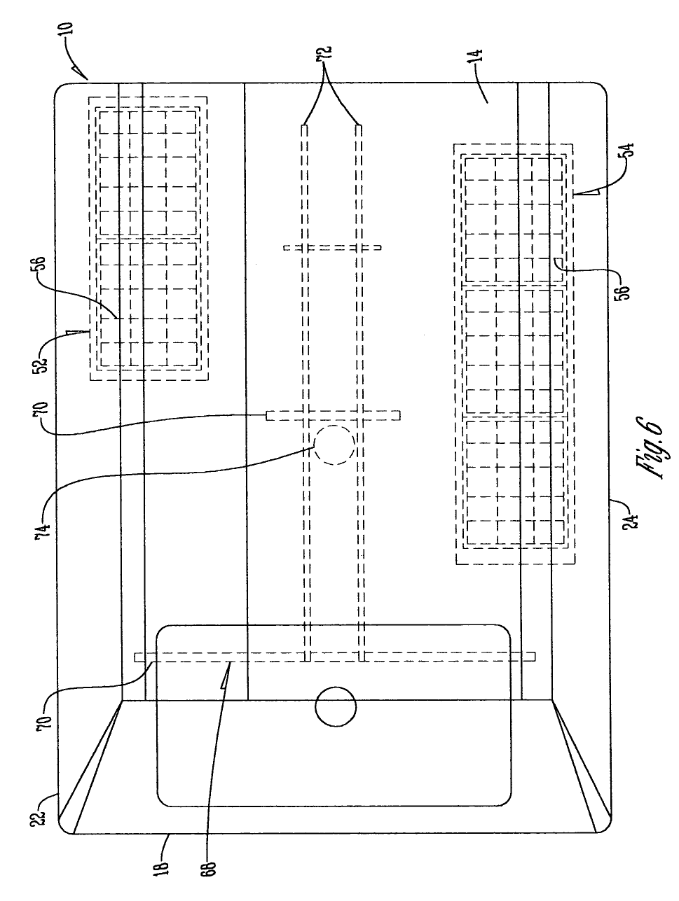

In another embodiment of the topper 10, an overhead ladder rack 68 is secured to the top 26 of the topper 10, as shown in FIGS. 3 and 6. Ladder rack 68 includes transverse members 70 secured to the top 26 of the topper 10. Longitudinal members 72 extend substantially the length of the topper 10 and are supported by the transverse members 70. Longitudinal members 72 support a ladder (not shown) placed thereon. Ladder rack 68 is preferably sized for step ladders six feet in length.

A dome light 74 is secured to the top 26 of the topper 10 and disposed therein to illuminate the bed 14 of the truck 16. Additionally, fixed and swivel J-hooks 78 may be secured to the top 26 of the topper 10 for storage of various tools or materials.

When the topper 10 is secured to the sidewalls 12 of a truck 16, the topper 10 covers the bed 14 and provides storage for tools, equipment, and the like. Specifically, tools may be placed on shelf portions 56 of shelving assemblies 52 and 54, or may be placed in compartments 60 underneath shelf portions 56. In this arrangement, the tools and equipment are accessible from outside the truck topper 10 via openings 34 and 36 in the sides 22 and 24 of the topper. Additionally, tools and equipment may be placed on tray 66 of pull-out tray assembly 62, which slides out through rear door 30 for easy access. Further, certain pieces of equipment may be suspended from J-hooks 76 and 78.

The topper 10 also provides storage for ladders. A ladder may be placed in ladder rack 68, thereby allowing the bed 14 of the truck 16 to be used for storage of large items. Alternatively, a ladder may be placed underneath tray 66 of the pull-out tray assembly 62, as shown in FIG. 7. In this manner, storage of a ladder uses a minimum of space, thereby allowing maximum storage inside the topper 10.

It is therefore seen that by the use of shelving assemblies mounted on interior side surfaces of the topper with side openings, this invention permits quick access to items stored on the shelving assemblies without limiting the storage space on the bed of the truck or impeding access into the topper through the rear door.

What is claimed is:

1. A topper having a front end, a rear end, a top, and sides for placement on the bed of a pickup truck, comprising:
an opening in at least one of the sides of the topper; and
a shelving assembly disposed within the topper adjacent the opening, the shelving assembly secured to the top and side of the topper.

2. The device of claim 1 wherein a ladder rack is secured to the top of the topper for supporting a ladder.

3. The device of claim 1 wherein a slide-out tray is secured to the bed of the truck and covered by the topper.

4. The device of claim 1 wherein the shelving assembly has a shelf portion.

5. The device of claim 4 wherein a compartment is secured to the shelf portion.

6. The device of claim 1 wherein a side door is hingedly secured to the side of the topper to cover the opening.

7. The device of claim 6 wherein the side door has a window.

8. The device of claim 1 wherein a dome light is secured to a bottom surface of the top of the topper.

9. The device of claim 1 wherein the rear end of the topper has at least one vent.

10. The device of claim 1 wherein the rear end of the topper has a brake light positioned above a rear door.

11. The device of claim 1 wherein the front and rear ends have windows.
